(19) United States
(12) Patent Application Publication
(10) Pub. No.: US 2025/0144875 A1
(43) Pub. Date: May 8, 2025

(54) BINDER JETTING PRINT CARRIAGE

(71) Applicant: Desktop Metal, Inc., Burlington, MA (US)

(72) Inventors: Eric WALKAMA, Burlington, MA (US); George HUDELSON, Burlington, MA (US); Joseph JOHNSON, Burlington, MA (US); Jamison GO, Burlington, MA (US); John SNIDER, Burlington, MA (US); William STONE, Burlington, MA (US); Andrew KUKLINSKI, Burlington, MA (US)

(21) Appl. No.: 18/839,746

(22) PCT Filed: Feb. 15, 2023
(86) PCT No.: PCT/US2023/013094

§ 371 Date: Aug. 20, 2024

Related U.S. Application Data
(60) Provisional application No. 63/312,292, filed on Feb. 21, 2022.

(51) Int. Cl. B29C 64/209; B22F 10/14; B22F 12/53; B29C 64/165; B29C 64/35; B33Y 10/00; B33Y 30/00

(52) U.S. Cl. CPC B29C 64/209; B22F 10/14; B22F 12/53; B29C 64/165; B29C 64/35; B33Y 10/00; B33Y 30/00

(57) ABSTRACT

A carriage unit for binder jetting additive manufacturing of components. A carriage body is movably mounted to a carriage frame within a printer unit and configured to traverse relative to a work surface. Two compaction rollers are mounted to the carriage body. Each is configured to move between a retracted position disengaged from build material powder to a deployed condition to recoat build material powder over a work surface. A powder dispensing unit is mounted to the carriage body and configured to dispense a metered amount of the build material powder as the carriage body traverses over the work surface. A print head mounted to the carriage body is configured to deposit a predetermined pattern of binder as the carriage unit traverses relative to the work surface.

### RELATED APPLICATIONS

This application is a US National Stage Application, filed under 35 U.S.C. § 371, of International Application PCT/US2023/013094, filed on Feb. 15, 2023 and claims priority to U.S. Patent Application 63/312,292, filed on Feb. 21, 2022; the contents of the above applications are incorporated by reference herein in their entirety.

### TECHNICAL FIELD

Various aspects of the present disclosure relate generally to systems and methods for binder jetting additive manufacturing using a bi-directional print carriage.

### BACKGROUND OF THE DISCLOSURE

Binder jetting is an additive manufacturing technique by which a thin layer of powder (e.g. 65 μm) is spread onto a bed, followed by deposition of a liquid binder in a 2D pattern or image that represents a single “slice” of a 3D shape. After deposition of binder, another layer of powder is spread, and the process is repeated to form a 3D volume of bound material within the powder bed. After printing, the bound part is removed from the excess powder, and sintered at a high temperature to bind the particles together.

### SUMMARY

Disclosed is a carrier unit and method of binder jetting which accomplishes printing in two directions. Particularly, a plurality of printing components are mirrored around a center such that after passing a build area in a first direction and printing with a first set of components, a carriage disposes a second set of components in position to print in a second, opposite, direction.

Components of embodiment print carriages include powder metering apparatuses, steaming units for providing steam to layers of build material, jetting heads for jetting binder and rollers. The rollers are moveable between retracted and deployed conditions, with each roller being retracted in one of the two directions of printing while the other recoats build material powder in preparation for binder jetting. In the deployed position the roller is indexed against a hard stop to provide the accuracy of build material layer height necessary for high quality printing.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 depicts a component schematic diagram of a binder jetting printer for use with embodiments of the present disclosure.

FIG. 2 depicts a cutaway view of the binder jetting printer of FIG. 1.

FIG. 3. is a schematic view of a first alternative binder jetting carriage assembly.

FIG. 4 is a schematic view of a second alternative binder jetting carriage assembly.

FIG. 5 is a perspective view of a binder jetting printer in which the disclosed carriage assembly may be employed.

FIGS. 6A-Q depict a carriage assembly and its components according to an exemplary embodiment of the present disclosure.

FIG. 7 depicts a gallery frame supporting a carriage.

FIG. 8 depicts a cantilevered frame supporting a carriage.

FIG. 9 depicts a schematic view of a third alternative binder jetting carriage assembly.

FIG. 10 depicts a cutaway view of a carriage assembly and a binder jetting unit and a binder reservoir.

FIGS. 11A-B are perspective views of a carriage assembly traversable via a motor system according to an exemplary embodiment of the present disclosure.

FIGS. 12A-B depict variations in height between various layers of build material powder.

FIGS. 13A-D depict flexures for mounting a carriage in certain exemplary embodiments of the present disclosure.

### DETAILED DESCRIPTION

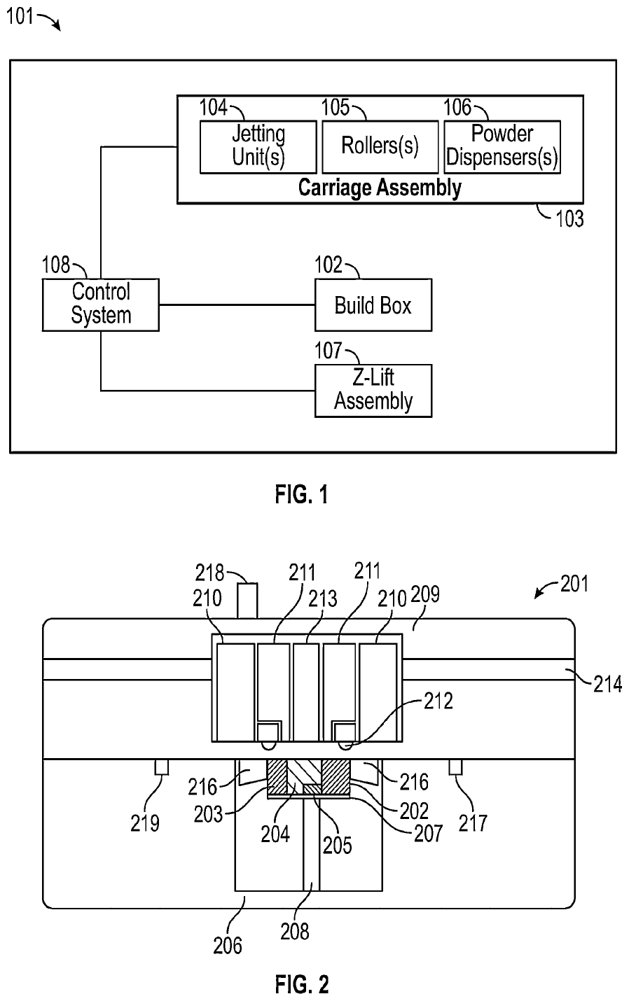

A binder jetting additive manufacturing system for which the present disclosure provides improvements includes a number of system components in a printer enclosure. With reference to FIG. 1, these include a build box 101 wherein articles are manufactured by the process of subsequent layers of powder that are bound in predetermined patterns of binder. A carriage assembly includes a jetting unit or units, a roller or rollers, and a powder dispenser or dispensers. The carriage assembly is moved relative to the build box during the printing process. In certain embodiments, the carriage assembly is assembly is traversed over the build box via an interface with a frame. The build platen within the build box is moved vertically with respect to the carriage during the printing process so that each successive layer of powder may be spread and binder jetted.

With reference to FIG. 1, a binder jetting printer 101 includes a build box 102 where a part is to be manufactured. A carriage assembly 103 is moved relative to the build box 102 to deposit successive layers of build material powder and binder to form parts. In certain embodiments, the binder jetting printer 101 can be used to manufacture metal parts. In these instances, the build material powder is metal powder, and the part is later sintered to densify the part. The carriage assembly includes jetting unit(s) 104 for depositing binder, roller(s) 105 for spreading powder layers prior to binder jetting and powder dispenser(s) 106 which meter build material powder for successively printed layers. In alternate embodiments, build material powder may be supplied from feed pistons adjacent to the build box and spread across the build box by means of the rollers or other spreading apparatus. In the embodiment of FIG. 1, the printer 101 includes a Z-lift assembly 107 which moves a build platen within the build box down as successive layers are printed. A control system 108 controls the various elements of the binder jetting printer 101.

FIG. 2 depicts a side cutaway view of a binder jetting printer 201. A build box 202 contains loose powder 203 and a part 204 being manufactured and potentially support structures 205. A Z-lift assembly 206 is configured to raise and lower the build box and build platen 207 to facilitate the printing process. A lift 208 raises and lowers a build platen 207. A print carriage 209 traverses relative to the build box. In the depicted embodiment, the carriage 209 moves while the build box 202 is maintained in a static position, though the build box 202 could alternatively move while the carriage 209 is maintained in a static position. In the depicted embodiment, the carriage 209 includes an arrangement of components for use in binder jetting. In the embodiment, the printing process is bi-directional, i.e., in a first direction-left to right with reference to the figure, and then from right to left. To facilitate bi-directional printing, the depicted carriage 209 may include several carriage process modules, which may include powder dispensing units 210, steamer units 211, a jetting unit 213 and roller units 214 having rollers 215. Downdraft system 216 is configured to collect excess build material powder dislodged during recoating of build material powder layers and convey the excess build material powder to a collection system via a stream of process gas to be collected and later reused. Sensor 217 is affixed to a frame of the binder jetting printer 201 a known distance in a z-axis relevant to a build surface and configured to measure a distance between the sensor and each of rollers 212. From the measurements a height of each of the rollers 212 above the build surface can be determined and adjustments to the Z-axis calibration of the rollers 212 can be made. Further, because each of the rollers 212 is measured by the same sensor 216, the relative heights of the rollers 212 can be determined and adjusted as needed for recoating of build material powder layers of consistent height. Powder refilling unit 218 is configured to discharge build material powder to refill powder dispensing units 210. In the embodiment, powder refilling unit 218 is positioned above a chute or chutes of downdraft system 216 such that build material powder spilled, leaked, or otherwise emitted during the refilling of powder dispensing units can be readily collected into the chute. When powder dispensing units are refilled, in some embodiments, the addition weight of build material powder contained within the powder dispensing units may cause a deflection, drooping, or otherwise undesired movement of one or more of the carriage process modules. In certain embodiments, the rollers 212 may move closer to the build surface due to the loading of additional powder. It may be desirable to compensate for this deflection by moving the build platen by a corrective distance determined to counteract the impact of the deflection. The corrective distance may be determined by means of modeling the deflection of carriage process modules (e.g. Finite Element Analysis) or by measurement of the position of the carriage process modules before and after dispensing units are refilled, or by any suitable means as will be understood by one skilled in the art. In an embodiment, it may be desirable to fill both powder dispensing units 210 from a single powder refilling unit 218 in the same location and in the same direction of carriage movement (i.e., first and second printing directions) such that the effects of weight fluctuations caused by the build material powder in powder dispensing units can be calibrated for consistently. In certain other embodiments, it may be desirable to fill a single powder dispensing unit 210 at a first time, and a second powder dispensing unit 210 at a second time, the first and second time separated by printing one or more layers as part of a binder jet printing operation, in order to more evenly distribute the effect of carriage deflection. In some embodiments, it may be desirable to ensure that after refilling one or both powder dispensing units 210, a binder jet printing operation will resume in the same direction as the last layers was printed. For example, if the last layer prior to a powder dispensing unit 210 occurred in a +X direction, the first layer after a powder dispensing unit 210 is refilled may occur in a +X direction. In this way, a single roller 212 may be used to perform the layer before and the layer after refilling the powder dispensing unit 212, which may in certain embodiments result in a more even and consistent layer thickness, since it may eliminate variations between the two rollers 212. A cleaning station 219 is configured to clean print heads of jetting unit 213. In at least one example, the cleaning station 219 is positioned such that while one or both of the powder dispensing units 210 are disposed to receive build material powder the cleaning station 219 is disposed to clean the print heads of jetting unit 213.

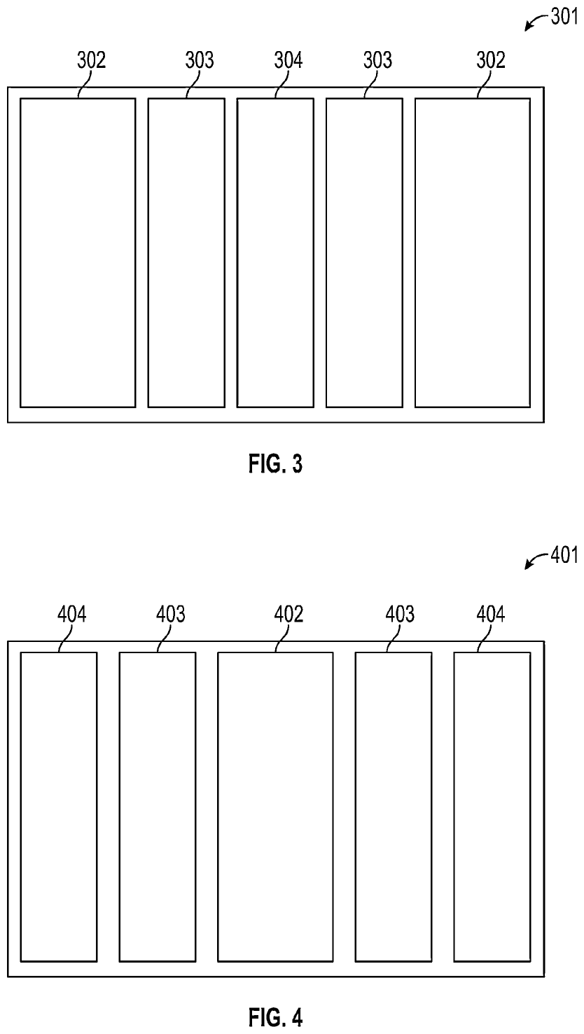

FIG. 3 depicts an alternative arrangement of printing components in a carriage 301, including powder dispensing units 302, jetting units 303 and a roller unit 304.

FIG. 4 depicts an alternative arrangement of printing components in a carriage 401, including a powder dispensing unit 402, roller units 403 and jetting units 404.

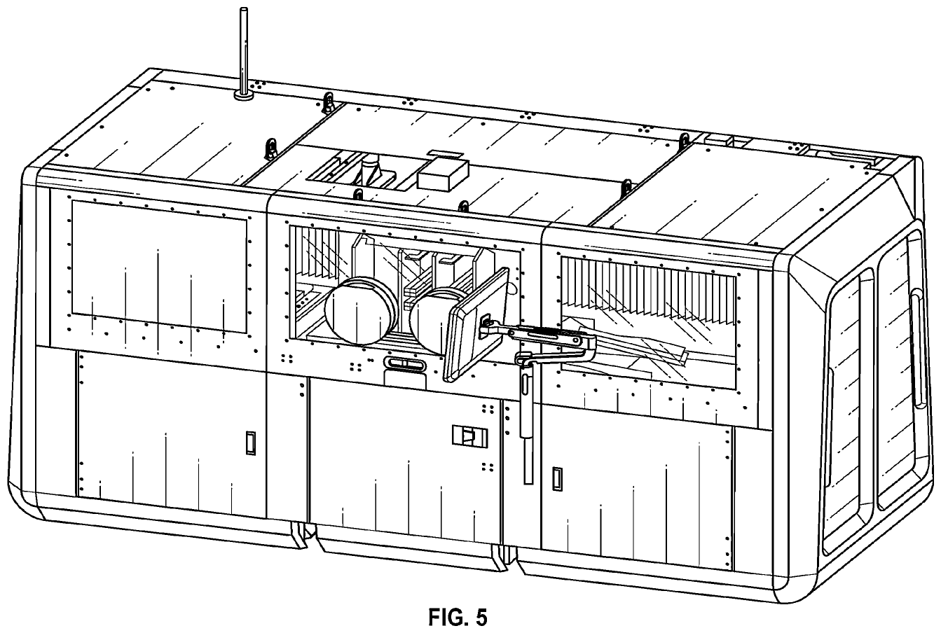

FIG. 5 is a perspective view of an embodiment binder jetting printer.

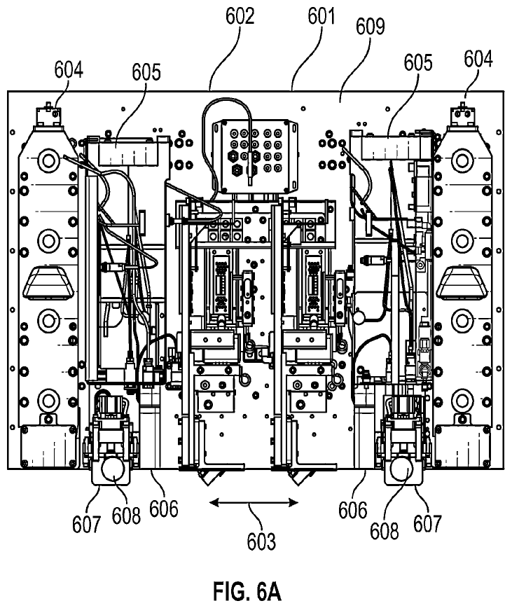

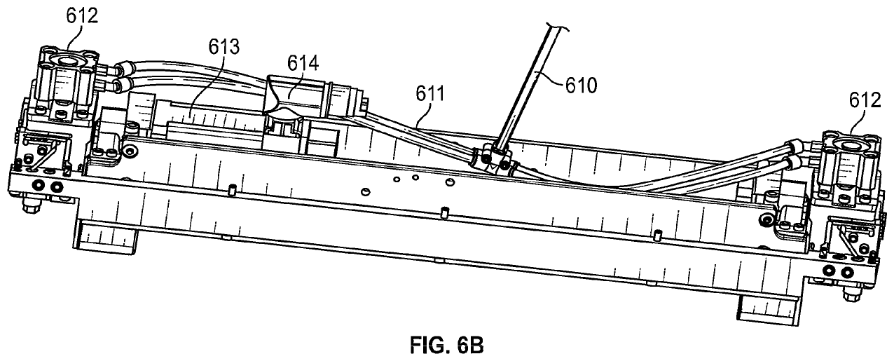

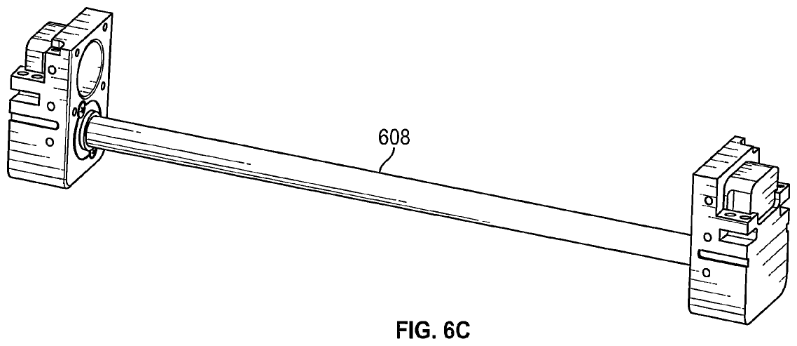

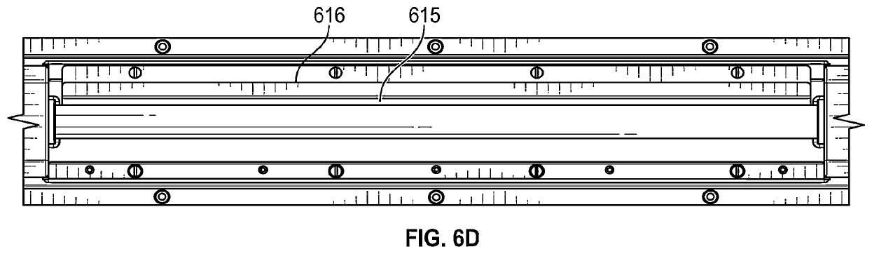

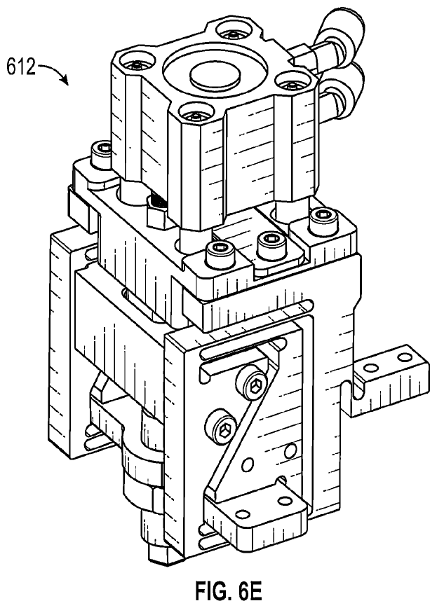

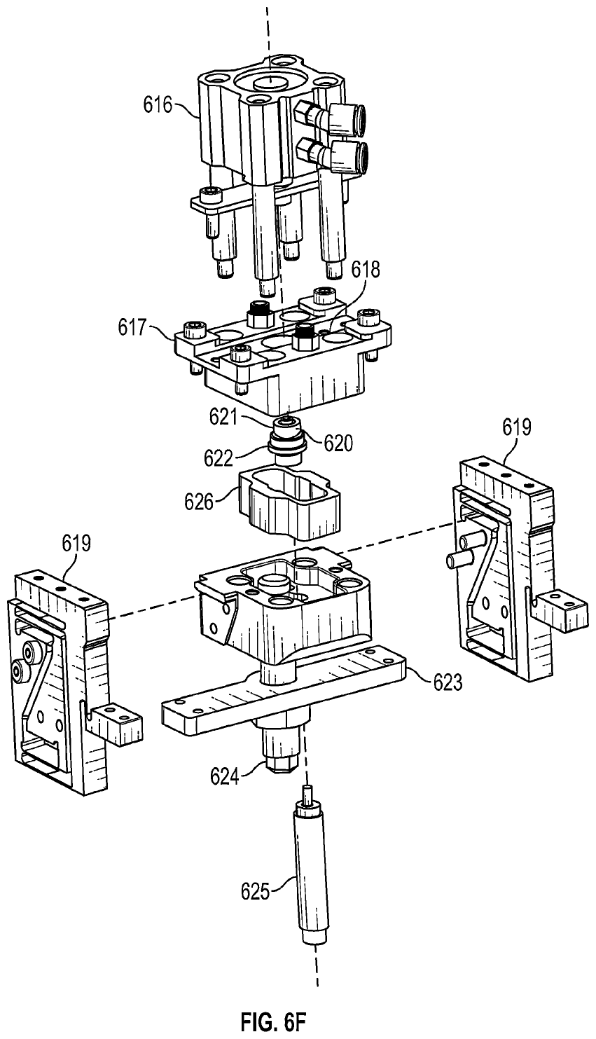

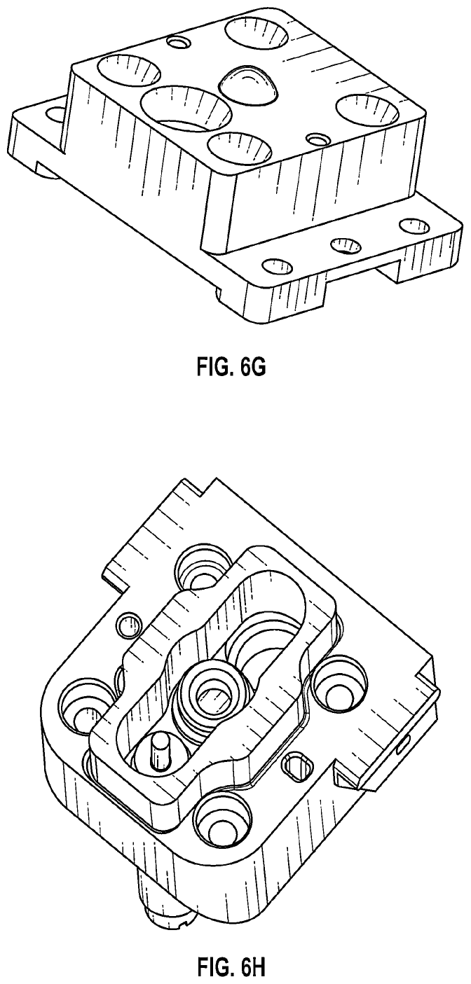

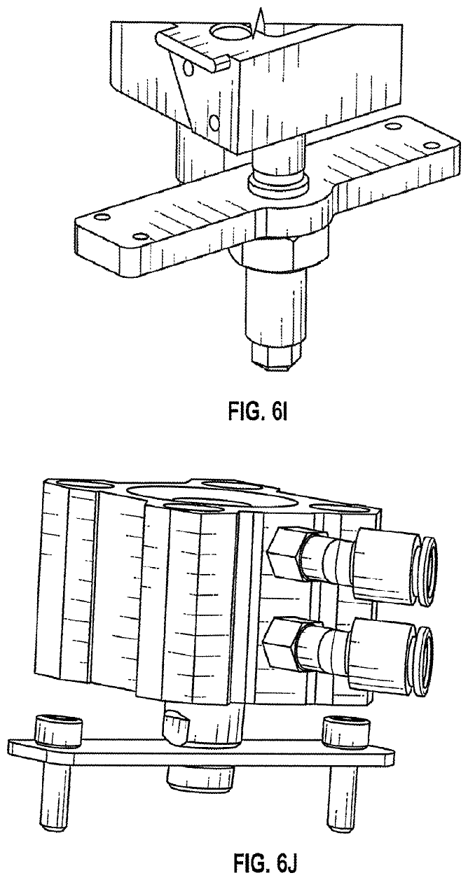

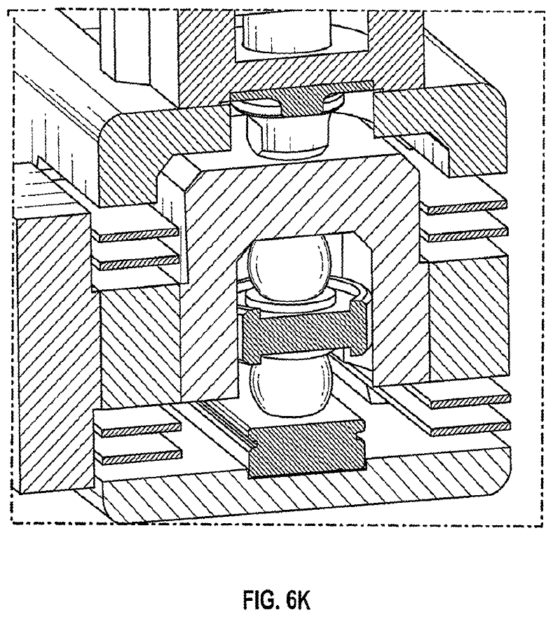

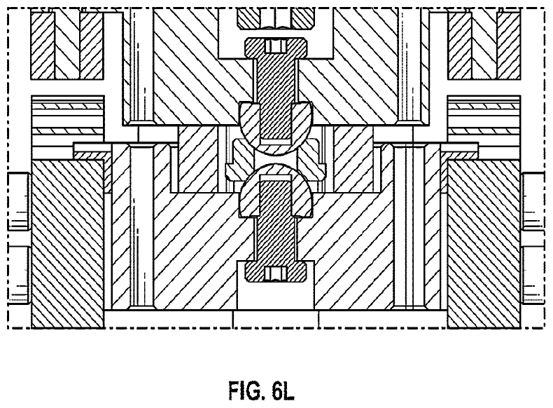

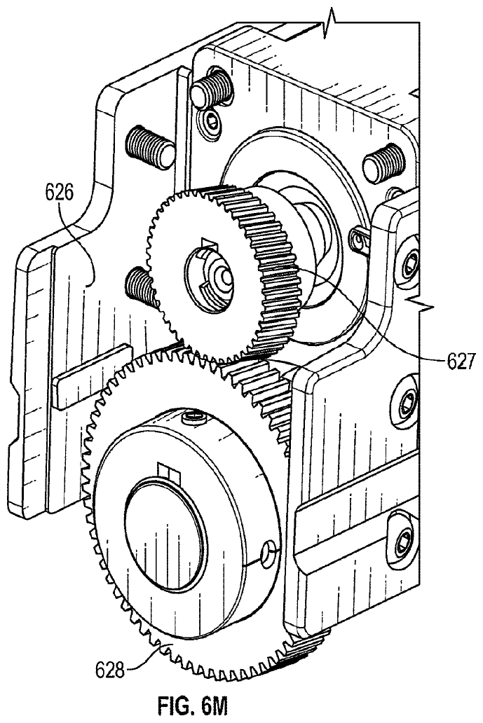

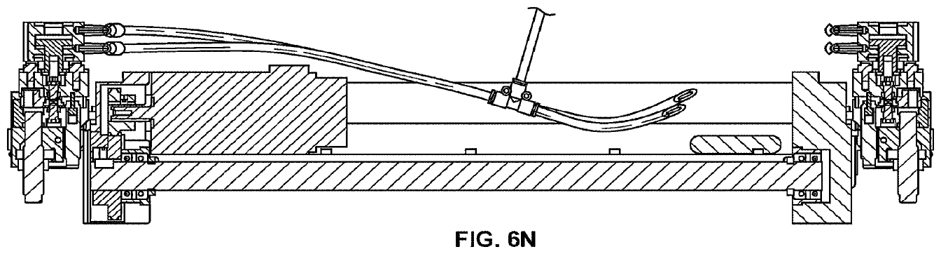

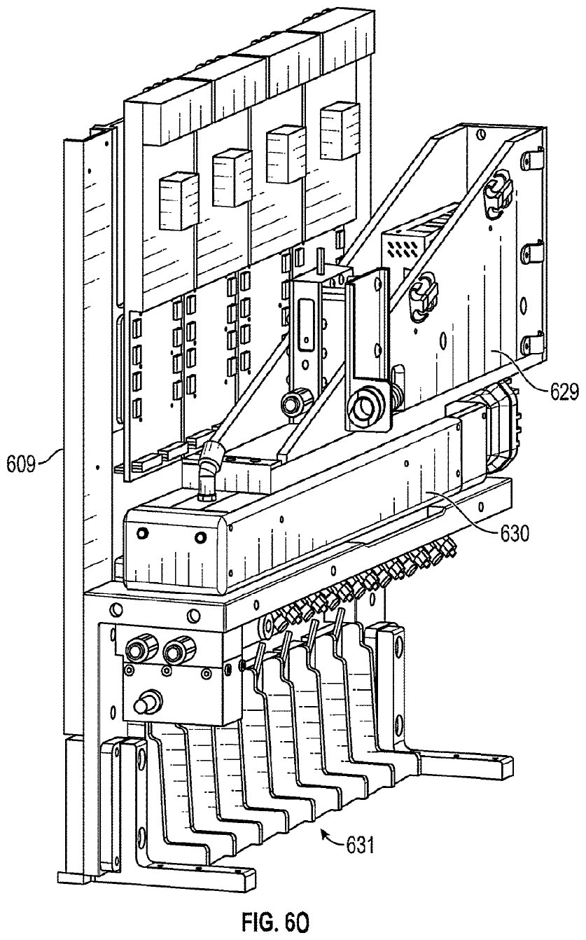

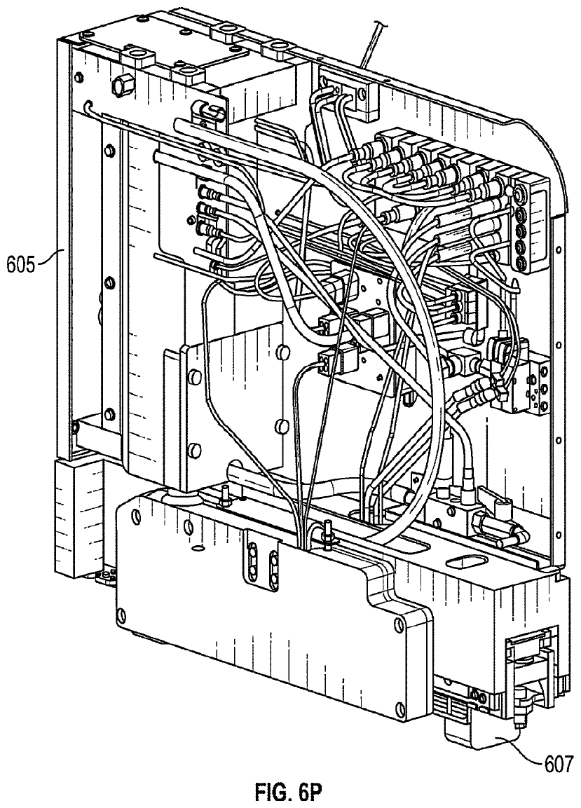

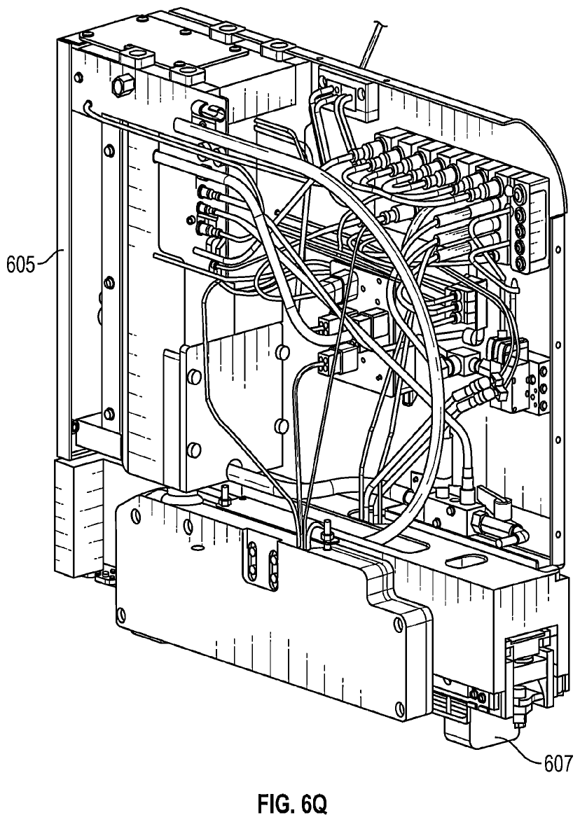

FIG. 6A is a side detailed view of an embodiment carriage 601. The various carriage components are mounted to cantilevered backplate 602 that provides bi-directional motion along an axis 603. Powder dispensing units 604 are hoppers of build material powder configured to meter out an amount of build material powder as the carriage traverses a build surface. Roller units 607 have rollers 608 which are configured to traverse between deployed and retracted positions, to spread the deposited powder and create a build material powder surface. Steamer units 605 provide steam through steam heads 606 to a build material powder layer prior to binder jetting, which may facilitate improved binder wetting and inhibits the ejection of powder particles by impacting binder droplets during the binder printing step. Jetting units 609 jet binder in predetermined patterns on layers of build material powder.

FIG. 6B is a perspective view of one of the roller units 610. A pneumatic system 611 includes a pair of pneumatic lift actuators 612 configured to move the roller between the retracted and deployed positions. A total distance traveled by the compaction roller assembly when actuated by the pneumatic system may be approximately 2 mm, and a total time for the compaction roller lift motion to occur may be less than 0.2 seconds. The pneumatic system 611 presents a reduced risk relative to electrical actuators which, in certain conditions, present an explosive hazard within the printer system. A sealed motor 613 provides rotation in the roller and receives power and control signal from a receptacle 614. A roller rotation rate as controlled by the motor may be in the range of 0 to 1500 RPM, and may be in a clockwise or counterclockwise direction. FIG. 6C depicts a perspective view of the roller 608. The roller may be manufactured to have a total runout of less than 10 μm, or for example, less than 5 μm. This may allow the use of two rollers for bi-directional printing, a first roller being used to spread the build powder in a first printing direction, and a second roller being used to spread the build material powder in a second printing direction. Controlling the surface profile (runout) of the two rollers to within a tight precision allows the layer height created in the first printing direction with the first roller to closely match the layer height created in the second printing direction with the second roller.

FIG. 6D depicts a plan bottom view of one of the roller units 607. A wiper 615 supported by a wiper holder 616 wipes the roller as it rotates to limit dispersion of powder above, in front, over, or behind the roller. In some embodiments, the wiper 615 may comprise a felt material. In some embodiments, a felt wiper 615 may be a wool felt, aramid felt, meta-aramid felt, polyester felt, or a blend of different materials, or any suitable felt material. In certain other embodiments, the wiper 615 may comprise a polymeric scraper disposed to contact the roller along its length and limit dispersion of powder above and in front of the roller.

FIG. 6E depicts a perspective close-in view of a pneumatic lift actuator 612. FIG. F is a exploded view of pneumatic lift actuator 612. An actuator 616 is configured to move a moving platform 617 and thus the roller 608. In the embodiment, the actuator 616 is a double acting cylinder, requiring a pneumatic force to both lift and lower the roller 608. Urethane tipped hard stops 618 stop against the lift head 616 in a retracted position. Guide flexures 619 constrain the motion of the moving platform to allow motion in the vertical direction while preventing rotation and translation in undesired directions (i.e. non-vertical directions), thereby maintaining alignment of the indexing stop. An indexing stop 620 includes two heads 621 having spherical bearing surfaces and a bearing 622 having conical bearing surfaces. The material of the heads 621 and bearing 622 may be selected to ensure a high material hardness, for example 440C stainless steel having a hardness of at least 58 on the Rockwell C scale. This may allow for minimal deformation of the bearings and surfaces, giving a repeatable positioning accuracy of less than 3 μm, or in at least one example, less than 1 μm variation across multiple actuations. A base plate 623 is fixed relative to the carriage 601 and includes a height adjustment differential screw 624, allowing for precise positioning of the indexing stop and thus the height of the roller in the deployed position. This allows for precise alignment of the two rollers on the carriage, ensuring that when layers are spread in the first direction and the second direction, the rollers creating the layer surface are aligned. In an embodiment, the alignment of the rollers may be calibrated to within 10 μm, or in at least one example, within 5 μm. A damper 625 serves to slow the motion of the moving platform as it approaches the deployed position, to reduce the impact between the indexing stops and prevent unnecessary wear. A foam sealer 626 dampens the end travel of the moving platform 617 to reduce wear on the indexing stop 620, and prevents the ingress of powder or other foreign debris into the hardstops, which could negatively impact their positioning accuracy.

FIGS. 6G-L are perspective views of the components of pneumatic lift actuator 612. Particularly, FIG. 6G depicts a bottom view of moving platform 617. FIG. 6H depicts base plate 623 and foam sealer 625. FIG. 6I depicts a lower view of base plate 623. FIG. 6K depicts the lift head 616. FIG. 6L depicts a first cutaway view depicting a close in view of indexing stop 620. FIG. 6M depicts a second side cutaway view of the indexing stop 620. FIG. 6N depicts a gear arrangement 626 in which a first gear of motor 627 drives a second gear 628 that rotates roller 608. Lastly, FIG. 6O depicts a cutaway view of roller unit 607.

FIG. 6P depicts a perspective view of a jetting unit 609. A carriage arm 629 is affixed to the carriage backplate 602. A shingling actuator 630 is affixed to the carriage arm 629 and suspends the remaining components of the jetting unit 609 including the printhead 631.

The process of shingling is now described in greater detail as follows. In certain embodiments, the printheads may be mounted to a device capable of indexing the printheads along an axis normal to the axis of carriage motion. This axis may be considered to be a Y-axis, in instances where the carriage motion is considered to be an X-axis. The device for indexing the printheads may be referred to as a shingling actuator, and the motion of the printheads produced by this actuator may be referred to as shingling. In some embodiments, shingling of the printheads (that is, motion of the printheads normal to their direction of travel during carriage motion) may be performed during periods when the printheads are not actively depositing binder during the binder jet printing process. In some embodiments, the indexing distance of the printheads may be a multiple of the resolution (that is, the pixel-to-pixel spacing) of the printheads.

For example, a printhead may have a resolution of 1200 dots per inch, corresponding to approximately 21.2 μm spacing between nozzles. In such a case, a shingling distance may be controlled to be a multiple of this, for example, 21.2 μm, 42.4 μm, 63.6 μm, or the like. A shingling motion may be performed between every printing pass of the binder jet printer, or after several passes based upon a pre-determined schedule, or at a time specified at the instruction of a machine operator. In certain embodiments, the shingling actuator may be configured to move the print head by a predetermined distance is determined by an algorithm.

In certain embodiments, the shingling motion of the printhead may comprise motion between two positions (a first position and a second position). In certain other embodiments, the motion may comprise a series of motions along a pre-determined range and between a minimum position and a maximum position. In some embodiments, the shingling actuator may comprise a high precision motion device, such as a linear motor, ball screw, lead screw, or the like. In other embodiments, the shingling actuator may comprise a pneumatic actuator configured to move the printheads between two or more positions. In some embodiments, the motion of the shingling actuator may be monitored and controlled by one of a linear encoder, rotary encoder, or other high-precision location sensing mechanism. In other embodiments, the shingling motion of the printheads may be controlled by moving the printheads against a repeatable stop (hard stop, or kinematic mount) in a first direction and a second direction (back and forth).

The shingling motion of the printheads may be matched by a corresponding shift in the data transmitted to the printhead commanding the printheads to print a 2D image as part of the binder jetting process. The shift in the image may be necessary to ensure that the part is printed as desired. For example, if the shingling actuator enacts a movement of 1 mm, the position of the image sent to the printhead may be shifted by 1 mm in the opposite direction, such that the resulting location of the image printed onto the powder bed are in the desired location. The shingling motion of the printheads and the compensatory shift of the printed image location may be according to a pre-determined schedule of motions which may be controlled by the system controller.

Shingling may be considered desirable, in certain embodiments, to mitigate the impact of certain failure modes that may be experienced by the printhead. As one non-limiting example, a printhead may have one or more nozzles which have become obstructed, blocked, clogged, misdirected, or are otherwise not functioning correctly. In a system lacking a shingling motion, the faulty nozzle or nozzles may fail to deposit binder over the same region of the build area on successive passes during a binder jet printing operation. This can lead to the creation of a weakened area in a green part, causing subsequent failure of the part. Now consider the case of a shingling operation with the same faulty printhead. During each successive pass, the defective nozzle or nozzles may not traverse the same region of the print bed. In this manner, the defect may be distributed over a larger, non-contiguous region of the parts being printed, and the negative impacts may be mitigated or eliminated. FIG. 6Q depicts a perspective view of a steamer unit 605 and roller unit 607.

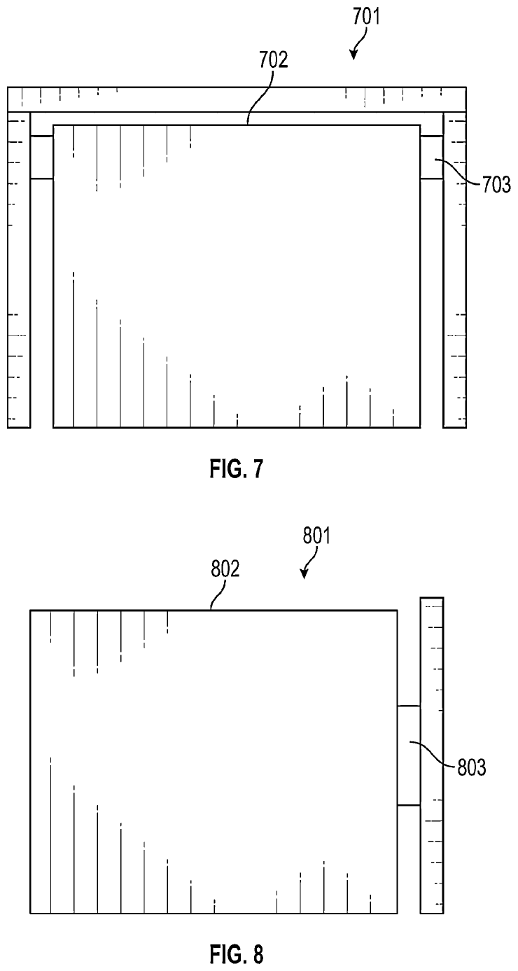

FIG. 7 depicts a side schematic view of a gallery frame style support in a binder jetting printer 701. A carriage assembly 702 is supported on two sides by a carriage frame 703.

FIG. 8 depicts a side schematic view of a cantilever frame style support in a binder jetting printer 801. A carriage assembly 802 is supported on one side by a carriage frame 803.

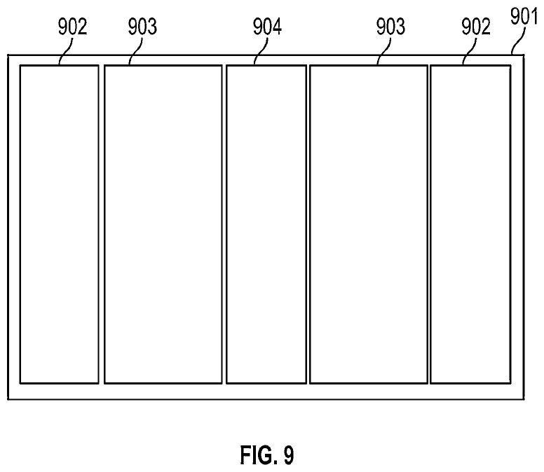

FIG. 9 depicts a further alternative arrangement of printing components in a carriage 901, including jetting units 902, powder dispensing units 903 and a roller unit 904.

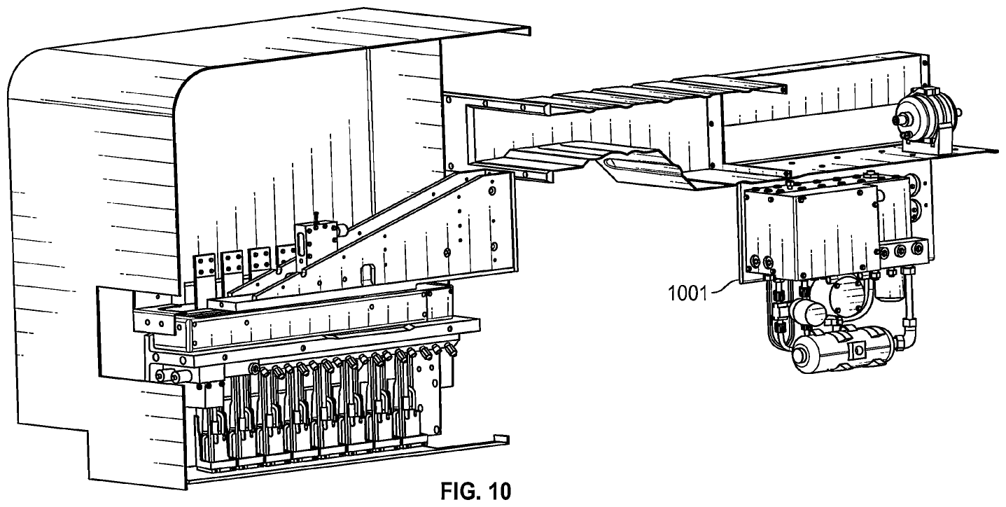

FIG. 10 depicts a cutaway view of a carriage including a binder jetting unit. A binder reservoir system 1001 supplies binder for binder jetting printing. The binder reservoir system may include a heater for heating binder recirculated through the system. In certain embodiments, it may be desirable to include the binder reservoir system 1001 on the carriage, to minimize the impact of pressure fluctuations in the binder supplied the printheads. In some embodiments the reservoir 1001 may be mounted such that a centerline of the reservoir 1001 in the direction of carriage motion may be aligned to within 10 mm, or in at least one example, to within 2 mm, of the centerline of the printheads in the direction of carriage motion. In such a way, as will be understood by one of ordinary skill in the art, pressure fluctuations resulting from acceleration of the carriage may be minimized in the reservoir 1001, printhead, and supply tubing between reservoir and printhead.

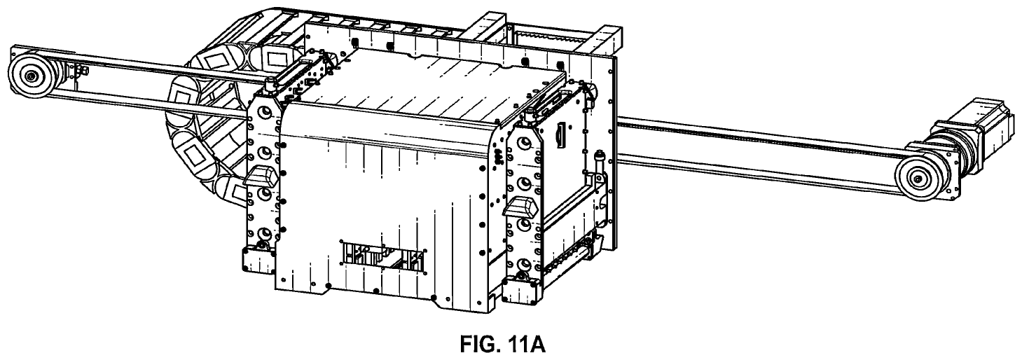

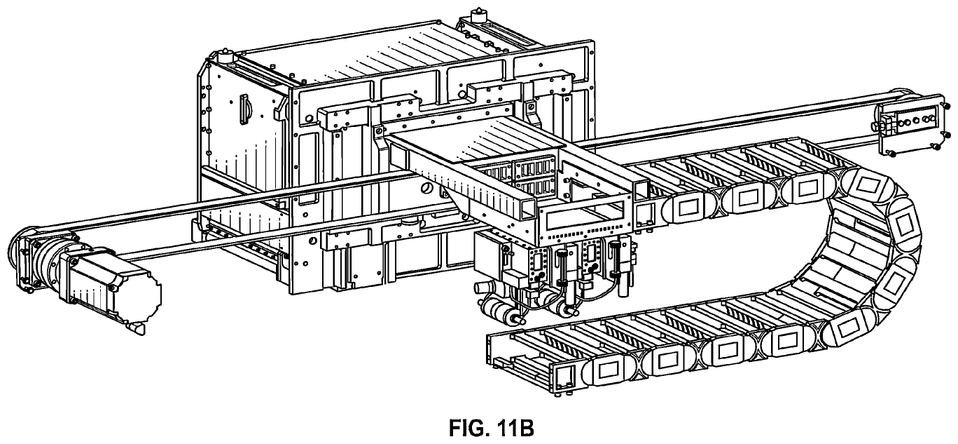

FIG. 11A depicts a front perspective view of an embodiment carriage assembly. FIG. 11B depicts a back perspective view of the embodiment carriage assembly.

When using two rollers to spread powder in alternating directions on alternating layers, misalignment between the two rollers may cause variation in the layer height. For example, if a layer height of 50 μm is desired, a misalignment of 25 μm between the two rollers at a particular location above the print bed may lead to the local layer height in a first direction to be 50-25=25 μm, while the local layer height in a second direction may be 50+25 μm=75 μm. In some cases, excessive variation may cause certain defects in the printed powder bed. By way of example, in the case of an actual layer height being less than a desired local layer height, the layer volume may be insufficient to hold the amount of binder deposited, leading to binder spreading beyond the defined part volume (a defect known as bleeding). As another example, in the case of an actual layer height being greater than a desired local layer height, the binder deposited may not penetrate completely through the powder to connect the new layer to the previously printed layers of powder, which may result in decreased strength of the part, or failure of the part along layer lines (a defect known as delamination).

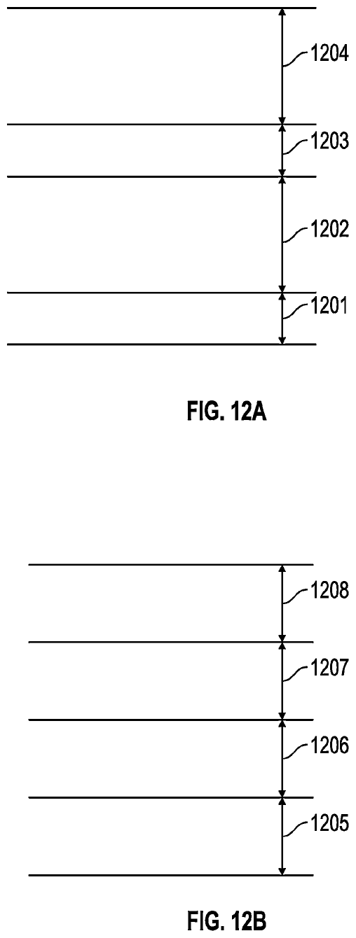

Varying layer height is illustrated in FIG. 12A, which depicts a first layer of spread powder 1201, a second layer of spread powder 1202, a third layer of spread powder 1203 and a fourth layer of spread powder 1204. Layers 1201 and 1203 are spread in a first direction by a first roller and have a height that is smaller than a height of layers 1202 and 1204 that are spread in a second direction by a second roller. This configuration is undesirable and can result in the problems discussed above. FIG. 12B depicts the desired result in which layers of powder 1205 and 1207 are spread in a first direction by a first roller exhibit the same height as layers of powder 1206 and 1208 that are spread in a second direction by a second roller.

Thus in some embodiments, the carriage and compaction roller mounting mechanisms may be constructed such that the two compaction rollers traverse substantially the same path above the build volume during their spreading motions (although in opposite directions). In some embodiments, the maximum deviation between the two rollers at a given location above the build volume may be controlled to be less than 20 μm, or in at least one example, less than 10 μm, and in at least one other example, less than 5 μm. The rollers may be constructed and configured to meet these maximum deviations, for example by means of an alignment procedure. For example, a measurement may be performed on each roller at a single location above the build volume, or at multiple locations above the build volume.

As will be understood by one of ordinary skill in the art, certain effects during printing may cause deflections in the carriage, such as thermal expansion due to heating or cooling, changing mechanical loads due to loading or dispensing powder, misalignment of the rails supporting the carriage, or other factors. Thus, the carriage may be designed to minimize deflection due to such forces. By way of non-limiting example, the carriage may be mounted to the skates or bearing blocks which move along the rails by means of mechanical flexures. The flexures may be designed to accommodate expansion in certain directions but limit or prevent deflection in certain other directions. For example, if a top rail and a bottom rail are used to support the weight of the carriage and guide its motion, misalignment between the top and bottom rail may lead to a varying distance between a top skate and a bottom skate attached to the carriage. In the case of a substantially non-compliant attachment between the carriage and the skates, the changing distance between the top and bottom skates may apply a load to the carriage, causing warping, bending, or other deflections, which may transmit to the compaction roller mountings and cause a displacement or deflection of the compaction rollers relative to one another or relative to the build surface. By the use of flexures designed to accommodate carriage expansion and rail misalignment in certain directions, the difference in bearing mounting location due to carriage expansion and spacing between the rails due to mis-alignment may be accommodated in the flexures while causing only minimal deflection in the compaction rollers (for example, less than 10 μm or in at least one other example, less than 5 μm). Flexures may be designed to accommodate thermal expansion of the carriage. Flexures may also be designed to isolate the carriage from deflection due loading or dispensing of powder from the metering hoppers.

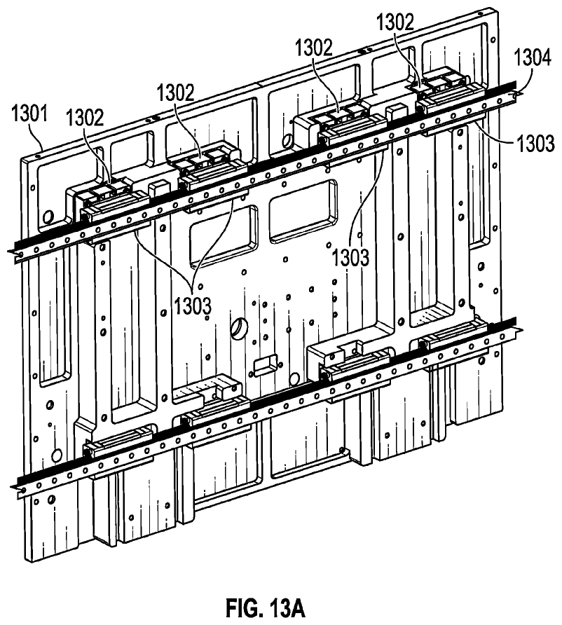

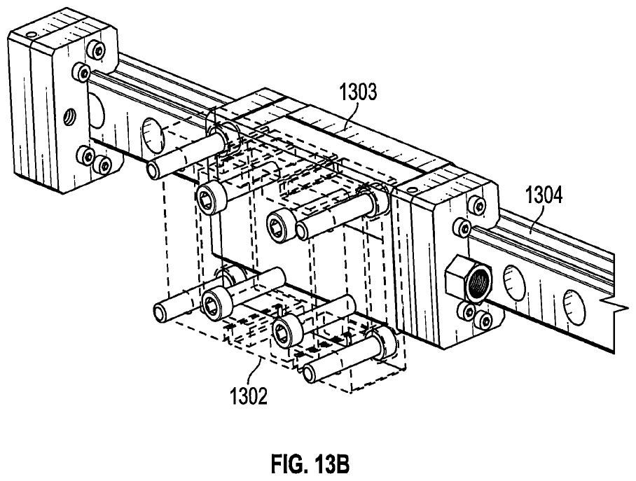

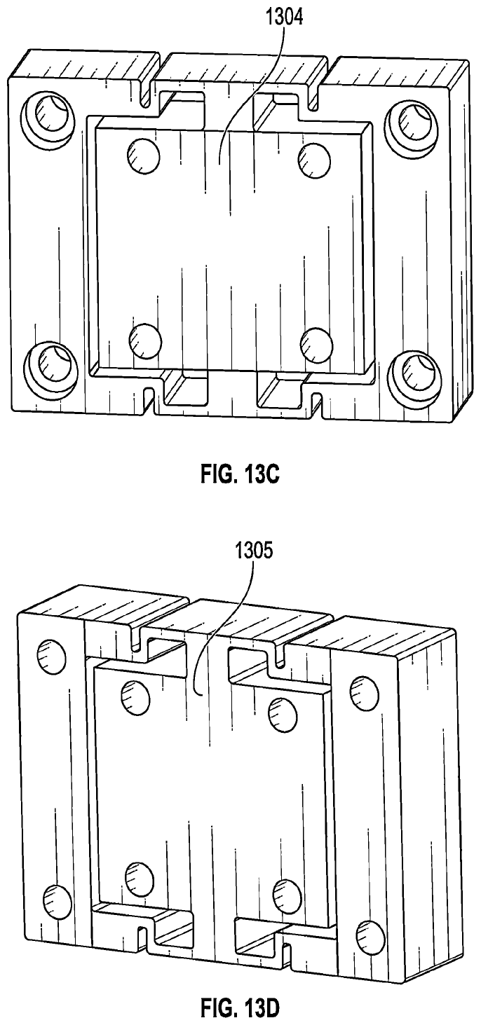

With reference now to FIGS. 13A-D, a carriage mounting plate 1301 has flexures 1302 that are interfaced with rail mounts (which may also be referred to as bearings or skates) 1303 which traverse along rail 1304. FIG. 13B is a close up of flexure 1302 and its interface with rail mount 1303. FIG. 13C depicts a bearing contact surface 1304 that interfaces with the rail mount 1303. FIG. 13D depicts a carriage plate contact surface 1305 that interfaces with the carriage mounting plate 1301.

In some embodiments, a certain amount of misalignment between the rollers may still be present after an alignment procedure. In certain cases, some degree of misalignment may be compensated for by means of a correction to the commanded layer height using the platen lift 208. For example, if a first compaction roller is known by measurement or modeling to be lower (that is, closer to the build platen) than a second compaction roller, then during a first spreading pass of the first compaction roller in a first direction, the build platen may be lowered by an additional amount than the nominal layer height (i.e. a correction distance), and when a second layer is spread by the second compaction roller in a second direction, the build platen may be lowered by a smaller amount than the nominal layer height (i.e. a negative correction distance). In this way, the correction and negative correction are alternated on alternating layers, such that the resulting actual layer height is closer to the desired (nominal) layer height, due to the compensation amount being equal to the difference between the two rollers. As will be understood by one of ordinary skill in the art, this method of compensation may be applied as a constant (that is, to account for a static offset between rollers), or may also be applied on a layer-to-layer basis to account for changing compaction roller deviations. For example, in the case that the amount of powder contained within the metering hoppers is known by modeling or measurement to causing deflections to the compaction rollers, the amount of correction may be modified to account for the changing amount of powder carried on the metering hoppers.

What is claimed is:

1. A carriage unit for binder jetting additive manufacturing of components, comprising:
a carriage body movably mounted to a carriage frame within a printer unit, wherein the carriage body is configured to traverse relative to a work surface;
a first compaction roller and a second compaction roller, each mounted to the carriage body;
wherein the first compaction roller is configured to move between a retracted condition disengaged from a first layer of a build material powder to a deployed condition kinematically mounted with respect to the carriage body and recoat the first layer of the build material powder;
wherein the second compaction roller is configured to move between a retracted condition disengaged from a second layer of the build material powder to a deployed condition kinematically mounted with respect to the carriage body and recoat the second layer of the build material powder;
a powder dispensing unit mounted to the carriage body and configured to dispense a metered amount of the build material powder as the carriage body traverses over the work surface; and
a print head mounted to the carriage body and configured to deposit a predetermined pattern of binder as the carriage unit traverses relative to the work surface.

2. The carriage unit of claim 1 wherein the first compaction roller and second compaction roller are each moved by a pneumatic actuator.

3. The carriage unit of claim 1 further comprising a displacement sensor configured to determine the Z-axis position of each of the first compaction roller and the second compaction roller, wherein the displacement sensor is affixed to the printer unit.

4. The carriage unit of claim 3 wherein the carriage unit is configured to adjust the Z-axis position of at least one of the first compaction roller and the second compaction roller according to the determined Z-axis position of the respective roller.

5. The carriage unit of claim 1 further comprising a differential screw configured to adjust a Z-axis position of each of the first compaction roller and the second compaction roller.

6. (canceled)

7. The carriage unit of claim 1 wherein the carriage frame is a cantilever frame.

8. The carriage unit of claim 1 wherein the carriage frame is a gantry frame.

9. The carriage unit of claim 1 wherein the printhead is mounted to the carriage body by a shingling actuator configured to move a print head relative to the work surface by a predetermined distance.

10. The carriage unit of claim 9 wherein the predetermined distance is determined by an algorithm.

11. The carriage unit of claim 1 further comprising a controller configured to conduct a powder refilling operation in only one of the first printing direction and second printing direction.

12. The carriage unit of claim 1, further comprising a binder reservoir system mounted to the carriage body.

13. A method of binder jetting additive manufacturing, comprising:
traversing a carriage assembly including a carriage body relative to a work surface in a first printing direction followed by traversing the carriage assembly relative to the work surface in a second printing direction;
wherein the carriage assembly includes:
a first compaction roller and a second compaction roller each mounted to the carriage body,
a powder dispensing unit mounted to the carriage body, and
a print head mounted to the carriage body;
wherein during the step of traversing the carriage body relative to the work surface in the first printing direction, depositing a metered amount of build material powder from the powder dispensing unit, recoating the amount of build material powder with the first compaction roller in a deployed position and kinematically mounted with respect to the carriage body, and jetting a first predetermined pattern of binder from the print head; and
wherein during the step of traversing the carriage body relative to the work surface in the second direction, metering from the powder dispensing unit an amount of build material powder, recoating the amount of build material powder with the second compaction roller in a deployed position and kinematically mounted with respect to the carriage body, and jetting a second predetermined pattern of binder from the print head.

14. The method of claim 13, further comprising:
during the traversing the carriage body relative to the carriage body in the first printing direction, retracting the second compaction roller to a retracted position; and
during the traversing the carriage body relative to the carriage body in the second printing direction, retracting the first compaction roller to a retracted position.

15. The method of claim 13, further comprising cleaning the print head at a printhead cleaning station while filling the powder dispensing unit with an amount of the build material powder.

16. The method of claim 13, further comprising heating the binder during a recirculation process.

17. A carriage unit for binder jetting additive manufacturing of components, comprising:
a carriage body mounted to a carriage frame within a printer unit, wherein the carriage body is configured to traverse relative to a work surface;
a compaction roller mounted to the carriage body and configured to recoat build material powder in a first printing direction and a second printing direction;
at least one powder dispensing unit mounted to the carriage body and configured to dispense a metered amount of powder as the carriage body traverses relative to the work surface; and
at least one print head mounted to the carriage body and configured to deposit a predetermined pattern of binder as the carriage unit traverses relative to the work surface.

18. The carriage unit of claim 17 wherein:
the at least one powder dispensing unit includes a first powder dispensing unit and a second powder dispensing unit;
the at least one print head includes a first print head and a second print head; and
wherein when moving in the first printing direction the first powder dispensing unit is configured to dispense build material powder ahead of the compaction roller and the first print head, and wherein when moving in the second printing direction the second powder dispensing unit is configured to dispense build material powder ahead of the compaction roller and the second print head.
